(19) United States
(12) Patent Application Publication
(10) Pub. No.: US 2025/0060810 A1
(43) Pub. Date: Feb. 20, 2025

(54) SYSTEM FOR MITIGATING ENVIRONMENTAL STRESSORS

(71) Applicant: Lightbrite Inc., Napa, CA (US)

(72) Inventors: Jaqueline Leonardini, Napa, CA (US); Deric Solis, Santa Rosa, CA (US); Eileen Gordon, Mill Valley, CA (US); Annabella Mineghino, San Mateo, CA (US); Rachelle Barrack, Santa Monica, CA (US); Daniel G. Miller, Santa Cruz, CA (US); Daniel C. Casciato, Fairview, NC (US)

(21) Appl. No.: 18/798,024

(22) Filed: Aug. 8, 2024

Related U.S. Application Data
(60) Provisional application No. 63/519,766, filed on Aug. 15, 2023.

(51) Int. Cl. G06F 3/01; G06F 3/16

(52) U.S. Cl. CPC G06F 3/011; G06F 3/165; G06F 2203/011

(57) ABSTRACT

A system for mitigating environmental stressors has a personal sensor device that includes sensors for collecting biometric data of the user, and a computer system for analyzing the data via a stress response system for detecting and mitigating the stress. The stress response system performs the following steps: collecting biometric data of the user via the at least one sensor of the personal sensor device; analyzing the biometric data using the stress response system to determine if a stress response has gone above a pre-determined threshold; if a stress response is detected, determining a mitigation response to the stress response, and providing the mitigation response; and if no stress response is detected, continuing to monitor the biometric data for additional stress responses.

### CROSS-REFERENCE TO RELATED APPLICATIONS

This application for a utility patent claims the benefit of U.S. Provisional Application No. 63/519,766, filed Aug. 15, 2023.

### BACKGROUND OF THE INVENTION

### Field of the Invention

This invention relates generally to systems and methods for monitoring a user's stress levels, and more particularly to a system and method that monitors a user's environment and physiological state, and takes steps to mitigate environmental stressors to assist the user in achieving a desired mental state.

### Description of Related Art

The prior art teaches many forms of systems and methods for determining a user's stress levels, and for assisting a user in his or her attempts to lower their stress. Some examples of prior art systems are discussed below:

Freckleton, US20220296847 (Happy Health, Inc) teaches a stress management apparatus which includes a wearable device having one or more physiological sensors operable to be engaged with a body of a user. One or more processors communicatively coupled with the wearable device having a memory storing instructions when executed operable to: detect one or more physiological indicators of stress; suggest a stress intervention to the user; monitor compliance with the stress intervention; and track a reduction of the one or more physiological indicators of stress.

Leon Villeda, U.S. 2012/0323087, teaches a well-being supervisions system for detecting an emotional state of a user, and generating commands and/or instructions for external devices whenever an emotional change is detected to compensate or alleviate the emotional change.

Milbert, U.S. Pat. No. 11,284,834 (Nightware, Inc.), teaches a system for detection and intervention of stress episodes such as nightmares during sleep activity (or flashbacks, anxiety attack, or similar stress episode). A heart rate sensor, for example, may be used for monitoring stress indicators indicative of a user's stress level. The sensed stress indicators may be used to calculate a stress level. If the stress level meets or exceeds a stress level threshold, haptic, audio, visual, and/or other feedback or alerts may be used to draw a user's attention (but not awaken the user) and thus interrupt the stress episode. Records of these interventions are maintained for later review.

Persen, U.S. Pat. No. 10,980,433 (Livmor, Inc.), teaches a wearable device that includes a photoplethysmographic (PPG) sensor to monitor heartbeat information of a user (HR, HRV, respiration rate), and determine whether the user is in a low stress state of a stressed state. The system then provides advice for reducing the stress level of the user (e.g., getting more sleep, meditation, reducing caffeine, etc.).

Vardas, U.S. Pat. No. 10,517,531 (Vardas, Inc.), teaches a wearable device that monitors biometric data of a user and enables feedback indications, such as haptic feedback (e.g., vibrations). Different states of HRV, for example, may be indicated by different patterns of vibrations.

Tanaka, U.S. Pat. No. 10,191,537 (Sony Corp), teaches a sensor system that includes sensors on and around a user which acquire biological and physical data in real time, which may be used to determine the physical and mental status of the user, at a particular instant, and also trends over time. The sensors may measure, for example, HR, O2 levels, blood sugar levels, temperature, and also location and altitude, air pollution, pollen count, distance traveled, external temperature, and similar data. The system then provides customized haptic feedback. Sensor information is used to provide the context for customizing the haptic feedback. Audio/visual feedback may also be provided. In one example, when the user is driving and shows signs of drowsiness, haptic feedback may be provided to stimulate the user to wake the user up.

Cruz-Hernandez, U.S. Pat. No. 10,289,201 (Immersion Corp), teaches a system for generating mood-based haptic feedback. A haptic system includes a sensing device, a digital processing unit, and a haptic generator. The sensing device is configured to detect the user's modalities in accordance with mood information collected by one or more sensors and capable of issuing a sensing signal in response to the user's modalities. The digital processing unit is capable of identifying a user's mood from the sensing signal and providing a haptic signal to another person that indicates the user's mood. For example, if two people are talking on cell phones with each other, haptic feedback that indicates the mood of first user may be transmitted to a second user via haptic feedback, so that the second user can receive feedback as to the first user's mood. In another embodiment, the mood of a driver (of a vehicle) may be determined, and communicated to third parties (this is what the claims are directed towards, determining fatigue, sobriety, etc. of a driver). In a third embodiment, the mood of a gamer is determined and used to adjust the conduct of the game, for example, adjusting the difficulty of the game.

Yoon, U.S. Pat. No. 10,314,534 (Samsung), teaches a system including a wearable electronic device that includes a biosensor configured to sense bioinformation on a body of a user wearing the electronic device. The electronic device also includes a controller configured to determine a state of the user based on the bioinformation and surrounding environment information of a surrounding environment of the user, and control a change in a function of the electronic device based on the state of the user. For example, detecting an “exercising” state will result in a watch band of a smart watch being tightened, while a “sleeping” state will result in the watch band loosening.

Rabin, U.S. Pat. No. 11,260,198 (Apollo Neuroscience, Inc.) teaches a system of assisting a subject to reach a target state by obtaining input of the target state of the subject; and generating a transcutaneous vibratory output to be applied to a portion of a body of the subject to assist the subject in achieving the target state, the transcutaneous vibratory output having variable parameters comprising a perceived pitch, a perceived beat, and a perceived intensity. The step of generating the transcutaneous vibratory output may further include the step of modifying the variable parameters to correspond to the target state. For example, layering sine waves produces an interference pattern that may be used to treat sleep disorders, chronic pain, anxiety, hypertension, depression, and many other conditions.

Goldberg, U.S. 2011/0245633 (Neumitra, LLC), teaches a wearable biosensor device which gathers physiological data from the wearer and uses this information over time to diagnose, detect, monitor, and treat psychological disorders. The device triggers real-time psychological treatments based on personalized estimates of the wearer stored on the biosensor device. A therapeutic stimulus is selected from a library based on the data received from the wearable biosensor device and relating to psychological condition(s), and that stimulus is delivered to the wearer via an associated display. The aggregate data from use of the device is provided to clinicians and/or patients.

While the prior art teaches systems with some generally similar methods of use, the prior art does not teach a system such as is claimed in the following claims. The present invention fulfills these needs and provides further advantages as described in the following summary.

### SUMMARY OF THE INVENTION

The present invention teaches certain benefits in construction and use which give rise to the objectives described below.

The present invention provides a system for mitigating environmental stressors affecting a user. The system includes a personal sensor device comprising at least one sensor for collecting biometric data of the user; and a computer system having a computer processor and computer memory, the computer memory storing a stress response system in the form of computer code that, when executed by the computer processor, enables the computer system to perform a process for detecting and mitigating stress. The stress response system performs the following steps: collecting biometric data of the user via the at least one sensor of the personal sensor device; analyzing the biometric data using the stress response system to determine if a stress response has gone above a pre-determined threshold; if a stress response is detected, determining a mitigation response to the stress response, and providing the mitigation response; and if no stress response is detected, continuing to monitor the biometric data for additional stress responses.

A primary objective of the present invention is to provide a system for mitigating environmental stressors, the system having advantages not taught by the prior art.

Another objective is to provide a system for mitigating environmental stressors that is able to gather data from multiple sources and determine if the user is being stressed, and what steps may be taken to mitigate the stress.

A further objective is to provide a system that is able to provide an active response in the form of an audio response (e.g., music, tonal responses, meditations, etc.) that are designed to mitigate the user's stress.

A further objective is to provide a system that is able to provide an active response in the form of a visual response (e.g., changes in illumination, patterns of lighting, colored lights, etc.) that are designed to mitigate the user's stress.

A further objective is to provide a system for mitigating environmental stressors that is able to detect artificial and/or engineered environments, and to take steps to mitigate the effect of the artificial environment.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is a block diagram of a system for mitigating environmental stressors according to one embodiment of the present invention.

FIG. 2 is a flow diagram illustrating the operation of the system.

FIG. 3 illustrates a person using the system in an artificial environment.

FIG. 4 is a perspective view of a charging case that may be utilized as part of the system of FIG. 1.

### DETAILED DESCRIPTION OF THE INVENTION

The above-described drawing figures illustrate the invention, a system for mitigating environmental stressors for a user.

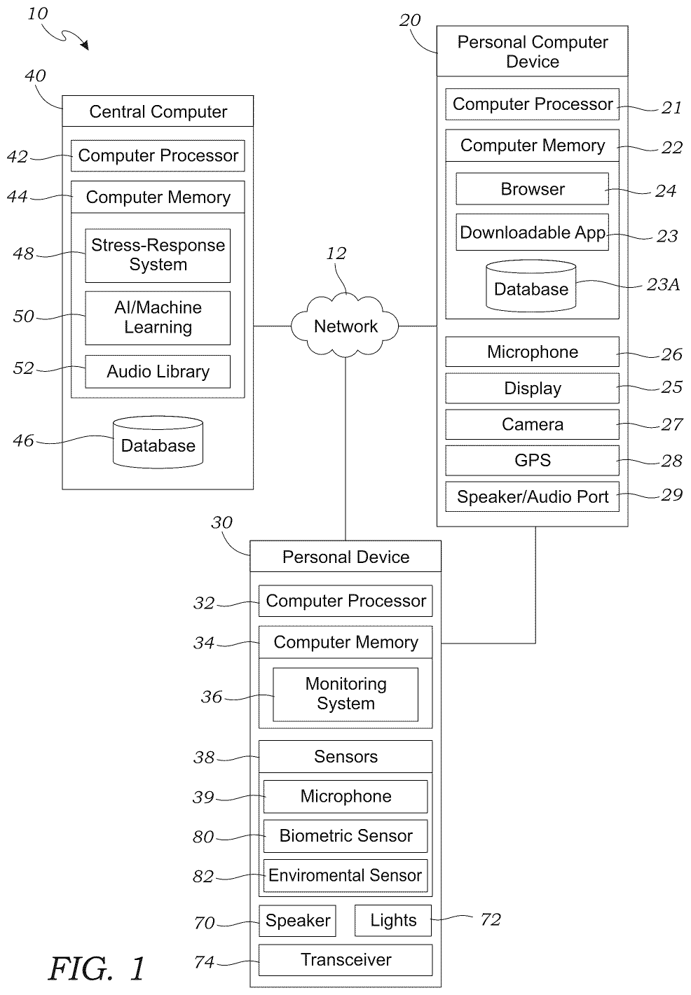

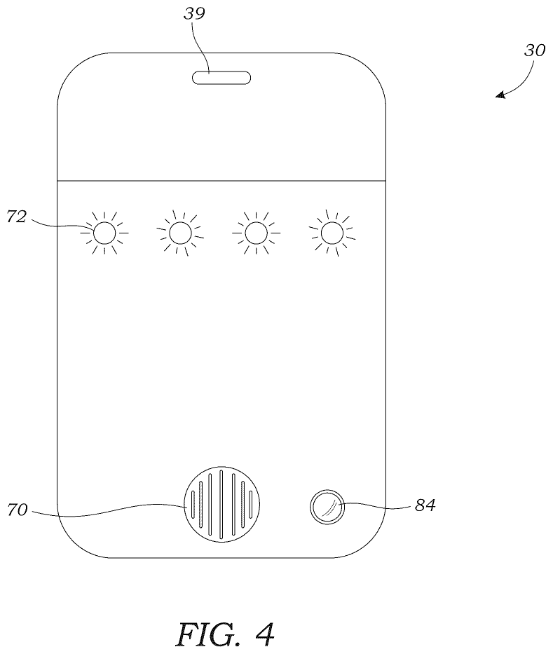

FIG. 1 is a block diagram of a system for mitigating environmental stressors 10 (the “system”) according to one embodiment of the present invention. As shown in FIG. 1, in this embodiment the system 10 may include a personal sensor device 20, in this case in the form of a personal computer device, and one or more personal/wearable devices 30 that the user may wear or carry on his or her person (such as, for example, a wearable device such as a smart watch, or a charging case, such as shown in FIG. 4)). The personal computer device 20 and the personal devices 30 may all be operably coordinated from and controlled by a central computer 40 running a stress response system 48, as discussed in greater detail below.

The personal computer device 20 may be any form of small, portable computer device commonly carried by the user, e.g., a smart phone, tablet, or any other similar device known in the art. The personal computer device 20 may operate software (e.g., a downloadable app 23) for performing many functions of the system 10, and the various accessories of the personal computer device 20 may be used for gathering data, and for also providing responses to mitigate stress for the user. These functions are discussed in greater detail below.

The personal device 30 may include sensors 38 for collecting data about different stressors that impact the stress level of the user. The sensors 38 may include, for example, biometric sensors 80 for measuring biometric data of a user, and/or environmental sensors 82 for measuring conditions in the environment around the user. The personal device 30 may be in the form of a wearable device that may be worn by the user; however, in alternative embodiments, the personal device 30 may be another form of item, such as an item the user might carry about his or her person.

The personal device 30 may be communicatively coupled with a personal computer device 20 such as a smartphone, which may operate in conjunction with a central computer 40 to detect and take steps to mitigate the effects of a given environment with a mitigation response. As discussed in greater detail below, the mitigation response may be in the form of audio, lights, music, temperature, haptic feedback (such as vibrations via the wearable device 30 and/or the smart phone), etc.

As shown in FIG. 1, all of the computer devices of the system 10 may communicate with each other via one or more networks 12. In this case the personal computer device 20 communicates with the wearable device 30 (or other form of personal device) via Bluetooth® or equivalent network known in the art, while the personal computer device 20 and the central computer 40 communicate via some form or larger network, such as the Internet, cellular networks, WIFI, and/or combination, as discussed in greater detail below.

The wearable device 30 is adapted to measure biometrics and other data of the user for analysis by the system 10. While one wearable device is illustrated, in the form of a watch, one or more of a variety of wearable devices may be operatively connected simultaneously (e.g. rings, various forms of wearable monitors, and any other such devices known in the art), which should be considered within the scope of the present invention.

The personal computer device 20 receives the data from the wearable devices 30, and performs at least some level of response, at least forwarding the data to the central computer 40, although larger amounts of analysis may be performed on the personal computer device 20 if the device 20 has sufficient processing speed, memory, etc., as discussed above. In this embodiment, much of the analysis is performed on the central computer 40, although in other embodiments, all of the functions of the central computer 40 could be performed on the personal computer device 20, and this configuration should be considered within the scope of the present invention.

In this embodiment, the personal computer device 20 comprises a computer processor 21 and a computer memory 22, the computer memory 22 storing executable code which may be in the form of the downloadable application (“app”) 23, a browser 24 (in conjunction with an associated web site), or any other configuration known in the art. The personal computer device 20 may further include a display 25, microphone 26, camera 27, GPS 28, and a speaker and/or audio port 29. Alternatively, the personal computer device 20 may include a means other than a speaker or audio port for transmitting audio, e.g., Bluetooth®, etc. In some implementations, the personal computer device 20 may be simplified to include fewer of these features, to be determined by one skilled in the art.

In this embodiment, the application 23 monitors the user and his/her surrounding environment. The app 23 may operate in conjunction with AI/Machine learning 50 (built into app, or as a separate module) to learn from experience the effects of different potential sources of stress on the user, and how different mitigation responses can affect these outcomes, discussed below. The app 23 of the personal computer device 20 can communicate with the central computer 40 via the network 12, allowing the transfer of user-specific biological and/or physiological data to the stress response system 48 from the wearable device 30. The personal computer device 20 can also communicate user-specific biological and/or physiological data to cloud-based computer services and/or cloud-based data clusters via the network 12, and in some embodiments can also receive data from a server and/or cloud-based computing service via the network 12. Alternatively, the wearable device 30 may directly communicate with the central computer 40 via the network 12, elaborated below.

As illustrated, the central computer 40 comprises a computer processor 42, a computer memory 44, and a database 46, wherein the computer memory 44 stores executable code that, when executed, enables the system 10 to perform the processes described below. In this embodiment, the executable code includes a stress response system 48 and an audio library 52, each discussed further below. The central computer 40 communicates with the personal computer device 20 and/or the wearable device 30 via the network 12. In some embodiments, the personal computer device 20 is in the form of a smart phone, but in other embodiments, it may be in the form of a tablet, desktop or laptop computer, smart watch, smart television, generic electronic processing and/or displaying unit, cloud storage or remote data repository, etc., or any other type of device capable of the essential functions described herein.

As shown in FIG. 1, the wearable device 30 comprises a computer processor 32 and a computer memory 34 having executable code in the form of a monitoring system 36. The wearable device 30 further includes at least one sensor 38, in some embodiments a plurality of sensors, that collect various forms of data that are impactful to stress levels of the user. In some embodiments, some of the sensors collect biometric data and/or physiological data from the wearer, discussed in greater detail below.

The sensor(s) 38 of the wearable device 30 may be in the form of any suitable sensors, in some embodiments including sensors designed to measure ambient light, sound waves, body temperature, blood pressure, heart rate, O2 levels, blood sugar levels, temperature, and also location and altitude, air pollution, pollen count, distance traveled, external temperature, and similar data. Examples of these types of sensors include, but are not limited to, an electrodermal sensor (EDA), galvanic skin response (GSR) sensor, a photoplethysmography (PPG) sensor, an electrocardiogram (EKG) sensor, an inertial measurement (IMU) sensor, an accelerometer, a gyroscope, a blood pressure sensor, a pulse oximetry (SpO2) sensor, a respiratory rate monitor, a temperature sensor, a humidity sensor, an audio sensor (i.e., a microphone), magnetometer, a thermistor, and combinations thereof. The one or more physiological sensors can also include thermal systems operable to measure temperature via infrared systems and/or thermocouples. Sweat quantification systems can be galvanic skin response and/or EDA. Pressure system can be implemented to monitor blood pressure, as is well-known in the art. Furthermore, the one or more physiological sensor can be an optical sensor including active and/or passive camera systems operable to quantify blood pulse volume, blood pressure, heart rate, heart rate variability, and/or optically opaque compounds (e.g. hemoglobin, etc.). In some configurations, the sensors 38 can have different numbers of emitters and photodetectors without departing from the principles of the present disclosure. Further, the emitters and photodetectors can be interchanged without departing from the principles of the present disclosure. In some embodiments, voice biometric libraries may be employed to analyze voice sound waves and deliver accurate diagnostics for health conditions and neurofeedback.

As mentioned, the sensors 38 can include the thermistor and the IMU (not shown). The IMU can be used to measure, for example, a gait performance of a walker and/or runner and/or a pedal kinematics of a cyclist, as well as one or more physiological parameters of a user. The thermistor and IMU can also serve as independent sensors configured to independently measure parameters of physiological threshold.

The sensor examples given herein are not exhaustive, and a wide range of other forms of physiological sensors may be implemented, as determined by one skilled in the art. The functions of these proposed sensors are enabled in the processes discussed below.

The wearable device 30 itself can include or be in the form of a watch, wristband, ring (e.g., a “mood ring,” “aura ring,” etc.), necklace, clothing (e.g. shirt, sock, underwear, bra, compression sleeve, etc.), adhesive patch, continuous glucose monitors (CGM), WHOOP STRAP®, other medical equipment, and/or combinations thereof, and any other sensors known in the art, or developed in the future.

In some embodiments, the monitoring system 36 can synchronize user-specific biological and/or physiological data with the personal computer device 20 and/or the central computer 40. Alternatively, the wearable device 30 may be adapted to receive data from a server and/or cloud-based computing service via the network 12. Communication between the wearable device 30 and the personal computer device 20 can be via any form of network known in the art. In at least one instance, the wearable device 30 can include a GPS module (not shown) configured to communicate with GPS satellites to obtain geographic position information.

The wearable device(s) 30 can be used by itself and/or in combination with other electronic devices and/or environmental sensors. In some embodiments, the system 10 can be communicatively coupled with one or more environmental sensors for providing information about a user's ambient environment and/or location. The one or more environmental sensors detect environmental conditions, such as a temperature sensor for measuring ambient temperature, a camera or light sensor for measuring ambient light intensity, a humidity sensor for measuring ambient humidity, and/or a GPS for determining the location of the user. The one or more environmental sensors can be disposed on the wearable device 30 and/or communicatively coupled with the personal computer device 20. In some instances, the one or more environmental sensors can include a smart thermostat operable provide ambient temperature information (e.g. room temperature), a smart light switch operable to provide ambient light intensity information, a smart hub operable to provide location information within a home, bathroom fixtures (e.g. scale, mirror, toilet with sensors, etc.), smart microphones, smart refrigerators, vehicles, and/or combinations thereof.

In at least one instance, the wearable device 30 can be used in combination with heart rate (HR) biosensor devices, foot pod biosensor devices, and/or power meter biosensor devices. In at least one instance, the wearable device 30 can also be used in combination with ANT+™ wireless technology and devices that use ANT+™ wireless technology. The wearable device 30 can be used to aggregate data collected by other biosensors including data collected by devices that use ANT+™ technologies. Aggregation of the biosensor data can be via a wireless technology, such as BLUETOOTH®, infrared technology, or radio technology, or via a wire(s).

In at least one instance, the downloadable app 23 and/or the monitoring system 36 and/or the stress response system 48 can employ machine learning algorithms by comparing data collected in real-time with data for the same user previously stored in the database 46 and/or in a cloud-based storage service. In other instances, data may be compared in real-time with data for other users stored on the database 46 of the central computer 40 and/or in cloud-based storage service.

For purposes of this application, the terms “computer,” “computer device,” “server,” and similar terms, refer to a device and/or system of devices that include at least one computer processor, and some form of computer memory having a capability to store data. The computer may comprise hardware, software, and firmware for receiving, storing, and/or processing data as described below. For example, a computer may comprise any of a wide range of digital electronic devices, including, but not limited to, a server, a desktop computer, a laptop, a smart phone, a tablet, or any form of electronic device capable of functioning as described herein.

The term “computer processor” as used herein refers to an electrical component that performs operations on an external data source, such as a computer memory, typically in the form of a microprocessor, although any equivalent structure may be used.

The term “computer memory” as used herein refers to any tangible, non-transitory storage that participates in providing instructions to a processor for execution. Such a medium may take many forms, including but not limited to, non-volatile media, volatile media, and any equivalent media known in the art. Non-volatile media includes, for example, ROM, magnetic media, and optical storage media. Volatile media includes, for example, DRAM, which typically serves as main memory. Common forms of computer memory include, for example, hard drives and other forms of magnetic media, optical media such as CD-ROM disks, as well as various forms of RAM, ROM, PROM, EPROM, FLASH-EPROM, solid state media such as memory cards, and any other form of memory chip or cartridge, or any other medium from which a computer can read. While several examples are provided above, these examples are not meant to be limiting, but illustrative of several common examples, and any similar or equivalent devices or systems may be used that are known to those skilled in the art.

The term “database” as used herein, refers to any form of one or more (or combination of) relational databases, object-oriented databases, hierarchical databases, network databases, non-relational (e.g. NoSQL) databases, document store databases, in-memory databases, programs, tables, files, lists, or any form of programming structure or structures that function to store data as described herein.

The network 12 may include any device or system for communicating information from one computer device to another. For example, a global computer network (e.g., the Internet) may be used, including any form of local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, enabling messages to be sent from one to another. In addition, communication links within LANs typically include twisted wire pair or coaxial cable, while communication links between networks may utilize analog telephone lines, full or fractional dedicated digital lines, Digital Subscriber Lines (DSLs), wireless links including satellite links, or other communications links known to those skilled in the art. The network may further include any form of wireless network, including cellular systems, WLAN, Wireless Router (WR) mesh, or the like. Access technologies such as 3G, 4G, 5G, and future access networks may enable wide area coverage for mobile devices. In essence, the wireless network may include any wireless communication mechanism known in the art by which information may travel between computers of the present system.

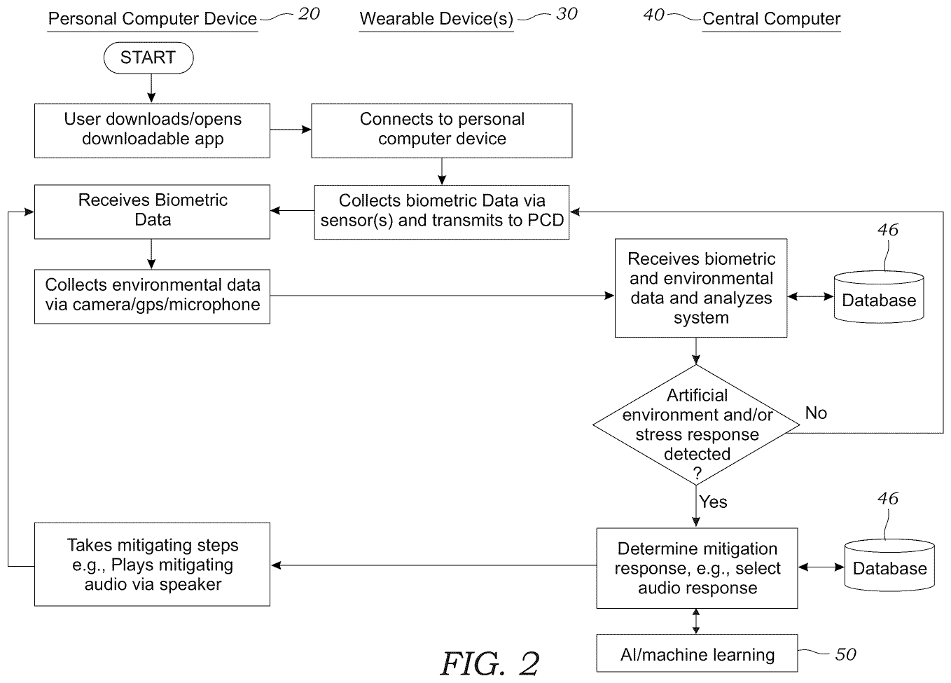

FIG. 2 is a flow diagram illustrating the operation of the system 10. As shown in FIGS. 1-2, a method of using the system for mitigating environmental stressors 10 comprises the steps of first using the personal computer device 20 to download and open the downloadable app 23 (via an app store, or any other method known in the art). In the embodiment of FIGS. 1-2, the app 23 operably connects with a stress response system 48 of the central computer 40, to perform any sign-up process that is required, and connect (synch) the personal computer device 20 to the wearable device 30 using methods known in the art. In an alternative embodiment, the user may access the stress response system 48 via the browser 24, instead of via the downloadable app 23.

The wearable device 30 then collects biometric data via the sensors 38 and via the monitoring system 36, and transmits the biometric data to the personal computer device 20. The monitoring system 36 may include an algorithm to determine selectively transmitted data, or it may automatically send all data to the personal computer device 20, either continuously or at predetermined periods of time. The wearable device 30 may be configured to measure a data point and provide it a user in real-time without providing the user ways to improve the particular data and/or interpret the provided data. In at least one instance, monitoring system 36 is operable to determine biological indicators, including, but not limited to a relative percentage, a saturation level, an absolute concentration, a rate of change, an index relative to a training threshold, and a threshold. As previously mentioned, the transmitted data may be sourced from multiple wearable devices and/or environmental sensors.

The personal computer device 20 receives the data from the wearable device 30, and further collects environmental data via the camera 27, microphone 26, and/or GPS 28, and any other sensor devices or mechanisms available. The personal computer device 20 may process this data itself, or it may transmit the data to the central computer 40 for analysis of the biometric and environmental data. The data and any analysis may be stored in the database 46.

In one example, a setup process may include an initial reading of the user's physiological data to establish a profile of the user. For example, the user may be prompted to speak into the microphone 26, wherein the app 23 will analyze the sound waves of the user's voice against data from the database 46. The stress response system 48 determines if a stress response has been detected, e.g., increased perspiration and/or heart rate, strain in voice, etc., and further analyzes if an artificial environment has been detected by the microphone 26, camera 27 and/or any other relevant sensors. For the purposes of this application, the term “artificial environment” is defined to include environments that are designed to induce a specific physiological and/or psychological response to any persons in that environment, via sounds (e.g., music, rhythmic patterns, audio clips, etc.), lighting (e.g., color, intensity, pulsing or flashing patterns, etc.), and/or any other systems and methods known in the art to artificially influence a person in an environment.

Responses such as stress can be measured and/or determined from the one or more physiological sensors 38 by determining a physiological change and/or combination of physiological changes experienced by a user. Examples of indications of stress include, but are not limited to, changes in heart rate, changes is respiration rate and depth, changes in core and/or skin temperature, sweating and/or peripheral vasoconstriction without a change in ambient temperature (via the one or more environmental sensors), changes in glucose levels (corrected for recent food ingestion), changes in skin conductivity and rate of sweat gland activation without physical activity, changes in peripheral perfusion, changes in heart rate variability (HRV), changes in blood pressure, movement deviation away from a normal patter (e.g. pacing), changes in vocalizations (e.g. volume, pacing, and/or tone), and/or combinations thereof.

The app 23 may then determine, based upon the analysis of the measured biometrics and/or environmental data via the display 25, desirable responses in response to the impact of the environment. The response may include reporting information to the user, and/or it may provide an automatic response to counter the effects of the environment, to achieve, for example, mitigation of stress or actions to enhancing the mood of the user.

At various points in the process, the user may be given options to select or edit preferences and intentions for using the app 23, to customize the system 10 to each individual. The system 10 may also provide feedback in the form of a guided meditation, or be played a custom sound/visual per the selected intentions and current biometrics.

If the stress response system 48 determines that the user is responding to the environment, in particular to an artificial environment that is detected, the system 10 may utilize various tools for countering the response, countering stress, or otherwise providing a beneficial influence on the user. For example, audio responses may be provided, such as stress-mitigating audio from the audio library 52. The audio may be transmitted to the app 23 on the personal computer device 20, or if the library is already provided, instructions may be provided as to what to play. The personal computer device 20 will then play the stress-mitigating audio to the user via the speaker 29. The stress-mitigating audio may be in the form of a repetitive tone, immersive soundscape, or similar audio intended to mask, counterbalance, or cancel the effects of the environment. The particular audio content will be guided by the teachings in the art of countering environmental influences, and can include any responses known in the art.

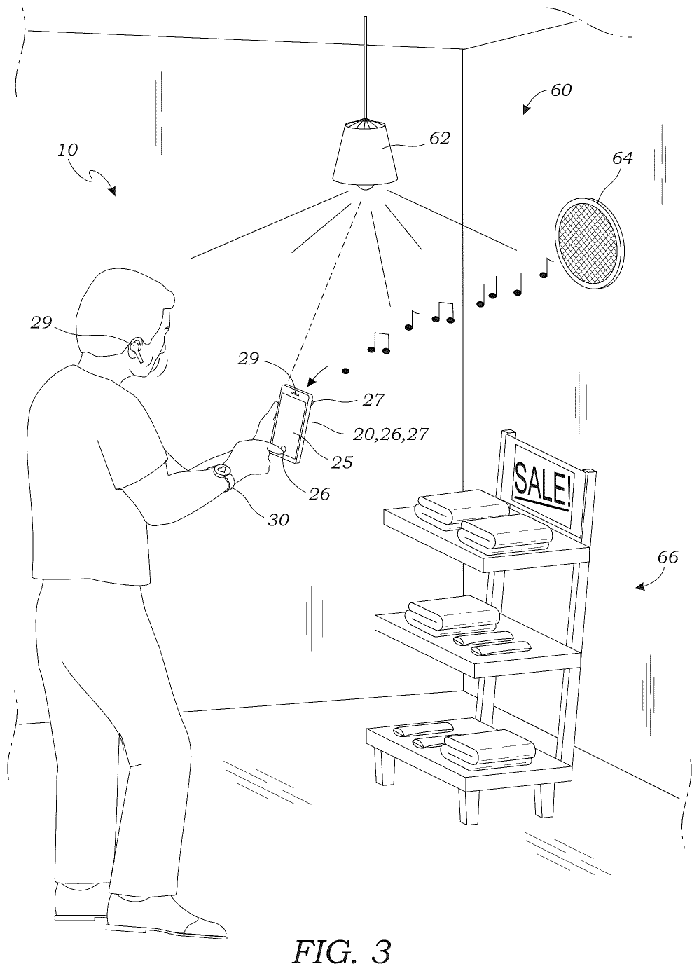

As stated, the speaker 29 may be a speaker on the personal computer device 20, or it may be a separate device, e.g., a wired or wireless earbuds (shown in FIG. 3), a speaker, headphones, etc. If no stress response or artificial environment is detected, the stress response system 48 continues to monitor data received.

In some embodiments, the stress response system 48 may also (or alternatively) provide or instruct mitigation responses that are non-audio in nature, such as a visual sequence, haptic feedback, temperature changes, etc., and/or a suggestion to walk, exercise, watch a video, perform a journal exercise, etc., or any other known means of mitigating stress and environmental effects. The user may also be alerted to a stress response or to an artificial environment, i.e., via haptic feedback, an audio alert, etc., before or instead of the mitigating response.

AI/machine-learning 50 tools may be employed to analyze different environments and the user's responses to different environments, and learn over time how to customize mitigation responses. For example, if the user periodically encounters a certain type of artificial environment, the system 10 can learn if the user has a certain response to this environment, and it can also learn how to counter the response, or even recommend avoiding a certain environment. If a certain environment, for example, leads to a great deal of stress to the user (which can often persist long after leaving the environment), the system 10 can either provide a response to mitigate this stress, or alert the user and recommend leaving or at least limiting time in the environment.

The wearable device(s) 30 can collect data and transmit to the personal computer device 20 to determine whether the stress intervention successfully reduced the one or more physiological indicators of stress. In at least one instance, an alert can be communicated from the monitoring system 36 of the wearable device 30 to the personal computer device 20 so that the user can be notified of a biological and/or physiological event (i.e., increased heart rate or perspiration). The wearable device 30 can determine a stress or pre-stress detection via measurements from the one or more physiological sensors 38 and/or the one or more environmental sensors. The stress or pre-stress detection can be indicated by changes in one or more physiological response by the user (e.g. increased perspiration) while accounting for the user's environment through the one or more environmental sensors. The stress or pre-stress detection can have a predetermined threshold for stress indication in view of the user information and/or user history and/or collective user data obtained through a cloud storage solution. In some embodiments, the user is able to track the history of use on the app 23 to gain insight into environmental effects and stress-mitigation, and further may be able to share and receive at least some of this information with others who also use the app 23.

FIG. 3 illustrates a person using the system 10 in an artificial environment. As shown in FIG. 3, in this embodiment, the wearable device 30 is in the form of a smart watch that may measure biometrics such as temperature, O2 levels, HR, and HRV (although it may also incorporate many other factors from many different sources. The wearable device 30 can be operably engaged with at least a portion of a user's body, in this case worn on the wrist, although other sensors may be worn or used differently. In other instances, the wearable device 30 can be operably engaged with the user via a wearable clothing item (e.g. shirt, pants, shorts, compression sleeve, sock, hat, helmet, patch, etc.). In various embodiments, the wearable device 30 can be secured to a selected muscle group, or using other techniques known in the art. As previously discussed, alternative or additional wearable devices may be used in the system 10, which should be considered within the scope of the present invention.

The personal computer device 20 may be in the form of a smart phone that includes the downloadable app 23, and is operably connected to the wearable device 30. As illustrated, the speaker 29 of the personal computer device 20 may be in the form of wireless ear buds worn by the user. The user will have already downloaded and configured the app 23 and connected the wearable device 30. In the example of FIG. 3, the user has entered a store having an artificial environment 60. Specific lighting 62, and an audio source 64, provide visual and audio cues that are intended to instigate a particular state (such as, in this embodiment, a desire to spend money to purchase merchandise 66, for example). This artificial environment 60 may be detected by the system 10, by sensors on the wearable devices 30, the personal computer device 20, and any other source of data. The system 10 is then able to determine the responses to the artificial environment, especially with reference to the AI 50 which will have made some determinations over time and experience.

Once the environmental data and the biometric data have been gathered and analyzed by the system 10, the mitigating response is determined and provided. The mitigating response may be audio, visual, haptic, etc., as discussed above, to achieve a desired response for the user. The response may also include healing meditations, steps to mask audio in the environment 60 (from speakers 64, for example), with audio provided by the system 10 to the speaker 29 (in this case, headphones) worn by the user. The wearable device 30 then collects biometrics to determine the effect of the mitigating response on the user, wherein machine learning algorithms may adapt subsequent mitigating responses. In some cases, the personal computer device 20 and/or the wearable device 30 may first alert the user of a notable change in environment and/or biometric data, so the user can manually select a mitigation response from the display 25 of the personal computer device 20, or simply leave the environment.

FIG. 4 is a perspective view of a charging case that may be utilized as part of the system of FIG. 1. As shown in FIG. 4, in this embodiment the personal device 30 is in the form of a charging case that is adapted for holding and charging wireless ear bud speakers (not shown). In this embodiment, the charging case includes a microphone 39 mounted on a top lid, a speaker 70 mounted on the case body for playing audio files, at least one light source 72 (e.g., a plurality of LED's) for providing light of predetermined colors, intensity, illuminated in predetermined patterns, for mitigating stress, responsive to the system 10. The case may further include a camera 84 for capturing images around the user, for determining, for example, light levels around the user, and also if the light patterns are being provided in any form of pattern (e.g., pulsing, strobing lights which may affect the user's stress levels and/or general mood). This may also assist in determining if the user is in an artificial environment. Data from all of these sources may be provided to the system 10, and feedback from the system 10 may be executed via any of the sources provided.

In one embodiment, the charging case of FIG. 4 is able to detect electronic fields, sounds, lights, and to receive other forms of feedback, and direction from the system 10, to then initiate verbal therapy provided by the system 10 to the user, to mitigate stress. The monitoring system 36 may provide an AI voice assistant, which may be used to provide soothing verbal feedback and instructions. The AI voice assistant may tell the user about what the system 10 is detecting, and discuss various options for response. The assistant may also just discuss the situation as a friend, allowing the user to vent stress and frustration.

The AI voice assistant is able to provide useful tools such as meditations, inspirational quotes, advice, as well as discuss various options that a user might take (listening to music, escaping a chaotic and loud environment, reading a book, meditating, etc.). The AI voice assistant may provide an empathic voice interface (EVI) so that discussions and instructions are soothing and helpful.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean+/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A system for mitigating environmental stressors affecting a user, the system comprising:
a personal sensor device comprising at least one sensor for collecting biometric data of the user; and
a computer system having a computer processor and computer memory, the computer memory storing a stress response system in the form of computer code that, when executed by the computer processor, enables the computer system to perform a process that comprises the following steps:
collecting biometric data of the user via the at least one sensor of the personal sensor device;
analyzing the biometric data using the stress response system to determine if a stress response has gone above a pre-determined threshold;
if a stress response is detected, determining a mitigation response to the stress response, and providing the mitigation response; and
if no stress response is detected, continuing to monitor the biometric data for additional stress responses.

2. The system for mitigating environmental stressors of claim 1, further comprising the steps of:
providing at least one environmental sensor on the personal sensor device for sensing environmental data about the user's ambient environment and/or location;
transmitting the environmental data to the stress response system;
analyzing the environmental data using the stress response system to determine if environmental factors are contributing to a user's stress levels; and
determining, if environmental factors are contributing to the user's stress, a mitigation response to help the user mitigate environmentally induced stress.

3. The system for mitigating environmental stressors of claim 1, wherein the personal sensor device is in the form of a personal computer device includes a display, microphone, camera, GPS, and a speaker and/or audio port.

4. The system for mitigating environmental stressors of claim 1, wherein the mitigation response includes sending stress-mitigating audio from an audio library of the central computer to a speaker proximate the user.

5. The system for mitigating environmental stressors of claim 4, further comprising the steps of:
determining whether the mitigation response successfully reduced the stress response; and
providing an additional mitigation response if the initial mitigation response was insufficient.

6. The system for mitigating environmental stressors of claim 1, further comprising the steps of receiving profile information of the user into stress response system and storing the profile information in a database.

7. The system for mitigating environmental stressors of claim 1, wherein the wearable sensor device includes at least one of the following sensors:
an electrodermal sensor (EDA), galvanic skin response (GSR) sensor, a photoplethysmography (PPG) sensor, an electrocardiogram (EKG) sensor, an inertial measurement (IMU) sensor, an accelerometer, a gyroscope, a blood pressure sensor, a pulse oximetry (SpO2) sensor, a respiratory rate monitor, a temperature sensor, a humidity sensor, an audio sensor, a magnetometer, and a thermistor.

8. The system for mitigating environmental stressors of claim 1, wherein personal sensor device includes executable code in the form of a monitoring system.

9. The system for mitigating environmental stressors of claim 2, wherein both the biometric data and the environmental data are utilized together to determined the user's stress levels.

10. The system for mitigating environmental stressors of claim 9, further comprising the steps of:
employing machine learning algorithms by comparing the biometric data and the environmental data collected in real-time, with stored data, to determine the user's stress.
